(19) United States
(12) Patent Application Publication
(10) Pub. No.: US 2021/0408857 A1
(43) Pub. Date: Dec. 30, 2021

(54) ELECTRIC MACHINE AND HYBRID ELECTRIC AIRCRAFT

(71) Applicant: Rolls-Royce Deutschland Ltd & Co KG, Blankenfelde-Mahlow (DE)

(72) Inventors: Matthias Böhm, Neuendettelsau (DE); Thomas Gleixner, Erlangen (DE); Peter Gröppel, Erlangen (DE); William Hunter, Ottobrunn (DE)

(21) Appl. No.: 17/280,857

(22) PCT Filed: Sep. 12, 2019
(86) PCT No.: PCT/EP2019/074324

§ 371 Date: Mar. 26, 2021

(30) Foreign Application Priority Data
Sep. 28, 2018 (DE) 10 2018 216 739.7

(51) Int. Cl. H02K 3/24; B64D 27/24

(52) U.S. Cl. CPC H02K 3/24; B64D 2027/026; B64D 27/24

(57) ABSTRACT

The invention relates to an electric motor comprising at least one winding having at least one electrical conductor (30) that has a non-circular-symmetrical cross-section and having at least one cooling-fluid conductor (60) that has a non-circular-symmetrical cross-section. The hybrid electric vehicle is in particular a hybrid electric aircraft and has such an electric motor (10).

This application is the National Stage of International Application No. PCT/EP2019/074324, filed Sep. 12, 2019, which claims the benefit of German Patent Application No. 10 2018 216 739.7, filed Sep. 28, 2018. The entire contents of these documents are hereby incorporated herein by reference.

### BACKGROUND

The present embodiments relate to an electric machine and a hybrid electric aircraft.

Among the limiting factors for the performance of electric machines is insulation. This insulation is not to overheat to provide the required reliability and projected service life. This requires cooling, for example, by air or liquid cooling. Liquid cooling achieves high heat transfer coefficients in electric motors, but liquid cooling is also disadvantageous.

This is because the electrical conductors of the stator of a high-power electric motor are usually cooled by cooling channels in the area of the laminated stator core. In addition to a reduction in magnetic efficiency, there is sometimes insufficient cooling, since the greatest electrical losses occur in the conductor and this is separated from the laminated stator core by mostly organic insulation. The insulation of electric machines often limits performance, as the heat loss that occurs cannot be dissipated efficiently enough. Due to the existing impregnation and the use of organic insulating materials, which have a low thermal conductivity, increasing the total heat transfer from the conductor to the cooling medium and consequently increasing the maximum power output remain a challenge.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an electric machine that may be cooled more easily and has a high mass-related power density is provided. As another example, a hybrid electric aircraft that has a high power density is provided.

The electric machine according to the present embodiments includes at least one winding with at least one electrical conductor with a non-circular-symmetrical cross section, and with at least one cooling fluid conductor with a non-circular-symmetrical cross section.

Using the non-circular-symmetrical cross section, the at least one electrical conductor and the fluid cooling conductor may be arranged alongside one another with a high filling factor. According to the present embodiments, a high filling factor of the at least one electrical conductor may consequently be achieved. According to the present embodiments, pressing of the at least one electrical conductor and the cooling fluid conductor is not absolutely necessary, so that in the case of the electric machine according to the present embodiments, the risk of damage to the at least one electrical conductor is significantly reduced.

A synergy between two properties of the electric machine according to the present embodiments may be achieved, increasing the performance of the electric machine: On the one hand, more efficient cooling of the electric machine is possible according to the present embodiments. Thus, according to the present embodiments, a cooling fluid conductor within the winding may be used to achieve significantly more efficient heat dissipation compared with superficial cooling of electrical conductors and, for example, of stranded wires. In addition, according to the present embodiments, an extremely high filling factor is possible, and thus, a high level of electrical utilization of a stranded-wire conductor made up of individual wires is possible. According to the present embodiments, as a result of the synergy of a high filling factor and efficient heat dissipation, an electric machine with a particularly high power density may be implemented.

In one embodiment, an electric machine according to the present embodiments may be easily produced. The cooling fluid conductor may thus be handled in the same way as the at least one electrical conductor during production. For example, in the case of the electric machine, the production, for example, of stranded wires with the at least one electrical conductor and the cooling fluid conductor may take place largely in the same way as the production of known stranded wires. The cooling fluid conductors may be processed in a conventional manner like individual electrical conductors.

The electric machine according to the present embodiments may also be created with a great freedom of design (e.g., with regard to electrical insulation), since the cooling fluid conductor may be arranged together with the at least one electrical conductor and no additional cooling fluid paths have to be provided or kept free.

In the case of the electric machine according to the present embodiments, the at least one cooling fluid conductor may have a cross section that is the same size as the at least one electrical conductor. In the context of the present embodiments, the same size may be, for example, a size within a tolerance range of at most 20 percent (e.g., at most 10 percent or at most 5 percent with regard to a surface area of the cross section and/or one dimension of the cross section).

In the case of the electric machine according to the present embodiments, the at least one electrical conductor and/or the at least one cooling fluid conductor suitably has at least 2-fold and at most 6-fold rotational symmetry.

In the case of the electric machine according to the present embodiments, the cross section of the at least one cooling fluid conductor and/or of the at least one electrical conductor may form a polygon.

Due to the polygonal cross section of the cooling fluid conductor and the at least one electrical conductor (e.g., with at least two-fold and at most six-fold rotational symmetry), the electrical conductor and the cooling fluid conductor or the electrical conductors and the cooling fluid conductor may be packed tightly, and there is more homogeneous and optimized heat dissipation of the at least one electrical conductor, so that a higher electrical power output of the electric machine may be achieved.

In the case of the electric machine according to the present embodiments, the polygon preferably forms a triangle, square, rectangle, or hexagon (e.g., regular). Such polygon shapes may be packed with a particularly high filling factor.

In a development of the present embodiments, in the case of the electric machine, the cross section of the at least one cooling fluid conductor and/or of the at least one electrical conductor forms a rounded polygon (e.g., a rounded triangle, a rounded square, a rounded rectangle, or a rounded hexagon).

In the case of the electric machine according to the present embodiments, the at least one cooling fluid conductor is suitably formed by at least one hollow conductor (e.g., a tube and/or a hose). In this development of the present embodiments, the tube or the hose may serve both as a casing for the cooling medium and as electrical insulation.

One or more cooling fluid conductors with a casing with a wall thickness of between 0.005 mm and 0.5 mm may be used. The outer diameter of the at least one cooling fluid conductor may be at least 0.1 millimeter (e.g., at least 0.2 millimeter and/or at most 10 millimeters or at most 4 millimeters).

In the case of the electric machine according to the present embodiments, the at least one cooling fluid conductor may be formed by plastic and/or by at least one metal (e.g., copper and/or aluminum). The metal may be electrically insulated (e.g., by anodized aluminum). Anodized aluminum may have, at the same time, a high thermal conductivity, since anodized aluminum has ceramic properties. At the same time, the anodizing of the surfaces leads to reduced losses in the aluminum. In contrast, the use of plastic as a cooling fluid conductor material is advantageous with regard to electrical insulation and thus the avoidance of eddy currents. For example, plastics that may be easily pressed at slightly elevated temperatures may be provided.

In the case of the electric machine according to the present embodiments, the at least one electrical conductor and the at least one cooling fluid conductor may form a stranded wire.

In addition, in further developments of the present embodiments, a Roebel transposition of the electrical conductor or conductors (e.g., of a stranded wire) may be provided, or a rearrangement of the electrical conductor or conductors may be provided.

The hybrid electric vehicle according to the present embodiments may be an aerial vehicle (e.g., an aircraft) and has an electric machine according to the present embodiments, as described above.

The hybrid electric vehicle according to the present embodiments may have at least one cooling circuit that has the at least one cooling fluid conductor. The cooling circuit may be, for example, a hydrogen cooling circuit that is configured for cooling by, for example, gaseous hydrogen. In one embodiment, depending on the system, hydrogen is available in hybrid electric aircraft for cooling high-temperature superconducting elements or for fuel cells.

### BRIEF DESCRIPTION OF THE DRAWINGS

FIG. 1 shows one embodiment of an electric machine with a winding package schematically in a basic diagram;

FIG. 2 shows one embodiment of the winding package of the electric machine according to FIG. 1 schematically in cross section;

FIG. 3 shows the winding package of the electric machine according to FIG. 1 in a further exemplary embodiment in cross section;

FIG. 4 shows the winding package of the electric machine according to FIG. 1 in a further exemplary embodiment in cross section; and

FIG. 5 shows an electric aircraft according to an embodiment with the electric machine according to FIG. 1 schematically in a plan view.

### DETAILED DESCRIPTION

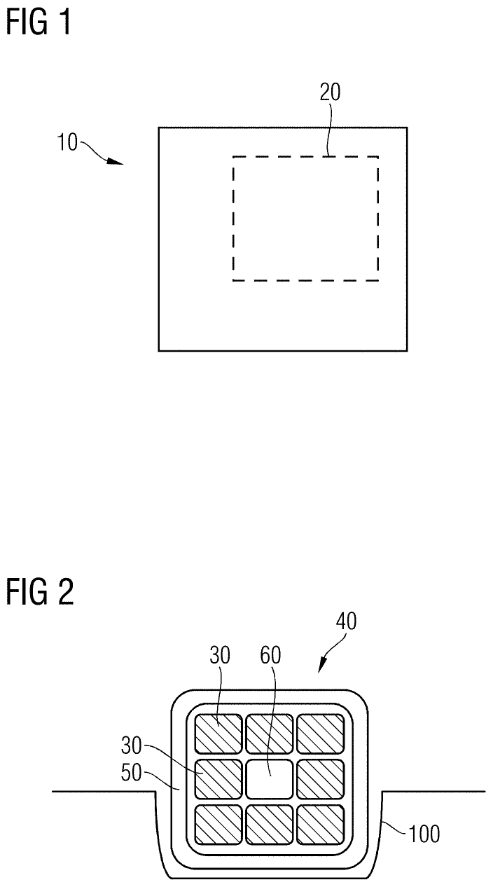

FIG. 1 illustrates one embodiment of an electric machine 10 that is an electric motor and includes a stator with a winding package 20 that is formed by copper wires 30.

The winding package 20 includes a number of stranded wires 40, as shown in FIG. 2. Each of the stranded wires 40 includes a plurality of copper wires 30 that bear against one another along corresponding longitudinal extents.

It is known to provide superficial insulation for the copper wires 30. According to the present embodiments, the electrical insulation of the copper wires 30 is implemented by aluminum oxide:

For this purpose, each of the copper wires 30 is coated with a layer of aluminum a few tens of micrometers thick. The aluminum deposited on the copper wire 30 is anodized in a manner known per se, so that a layer of aluminum oxide then remains on the copper wire 30 instead of the original layer of aluminum (the layer of aluminum oxide is not explicitly shown in FIG. 1). In the case shown, the layer of aluminum oxide is approximately 50 micrometers thick and has a dielectric strength of 1213 volts.

The stranded wires 40 are not only electrically insulated with regard to individual copper wires 30, but rather, the stranded wires 40 are also electrically insulated from one another to provide the dielectric strength. For this purpose, the stranded wires 40 are held together by a plastic tube 50 that is coated with aluminum oxide. For this purpose, the plastic tube 50 is formed in a manner known with a plastic that, according to the present embodiments, has initially been coated with aluminum on the surface on an inside and on an outside; the aluminum is then anodized.

In principle, in further exemplary embodiments not specifically shown, an aluminum tube that is anodized on the surface may also be used instead of a plastic tube 50. In this way, the aluminum tube is coated with aluminum oxide. In this further exemplary embodiment, the aluminum tube surrounds the stranded wires 40 instead of the plastic tube 50.

The stranded wires 40 have one or more cooling fluid conductors, in each case in the form of a copper tube 60 that has a cross section that is identical to the cross section of the copper wires 30. The copper tube 60 is pressed together with the copper wires 30 to form a tight packing. As a result, the copper tube 60 forms flaws in the cross sections of the copper wires 30. In further exemplary embodiments not specifically shown, hollow conductors of other metals (e.g., of aluminum or of brass or brass alloys) may take the place of the copper tube 60. Further, actual flaws in the tight packing of copper wires 30 alone may already form a cooling fluid conductor. In these exemplary embodiments, the copper wires 60 adjacent to the flaws therefore form the cooling fluid conductor to a certain extent. As a result of a respective insulation of the copper wires 30, separate insulation of the flaws may be unnecessary.

In further exemplary embodiments not specifically shown, the hollow conductor may also be formed by or from a plastic, or by or from a ceramic, and/or by or from a composite material, and/or by or from carbon fibers. The hollow conductor suitably has wall thicknesses of at least 0.002 millimeter (e.g., at least 0.005 millimeter and at most 0.5 millimeter or at most 0.1 millimeter).

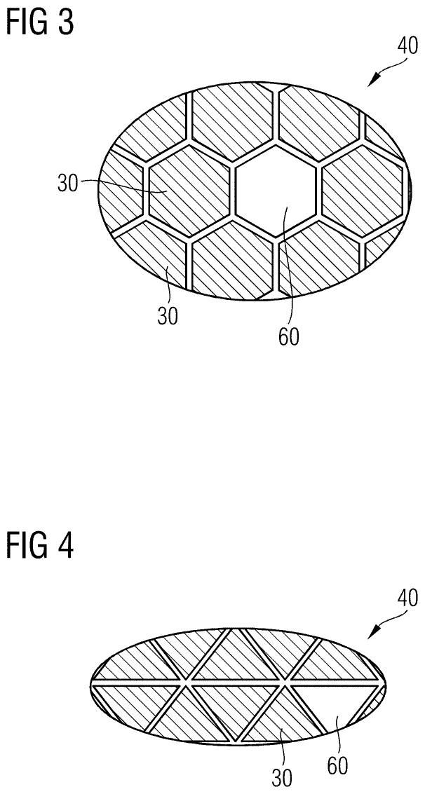

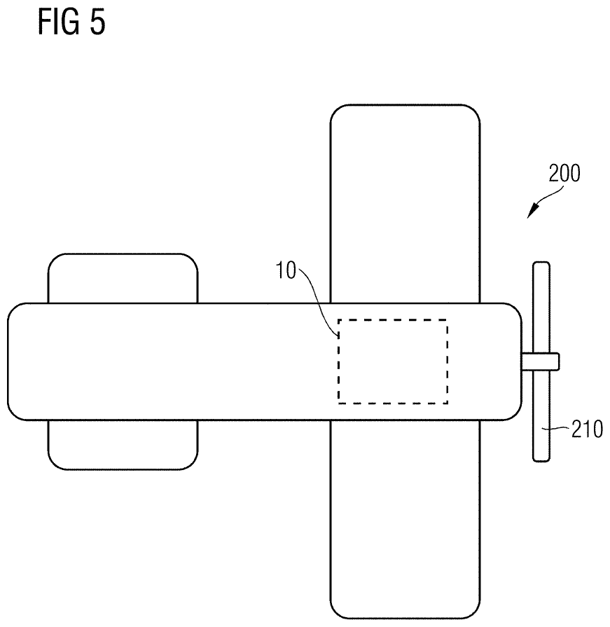

As shown in FIG. 2 to 4, the stranded wires 40 have copper wires 30 with a cross section other than a round cross section: Thus, as shown in FIG. 2, the individual copper wires 30 may have an essentially rectangular cross section or an essentially hexagonal cross section, as shown in FIG. 3, or an essentially triangular cross section, as shown in FIG. 4. In this context, the phrase “essentially” only provides that the cross sections of the copper wires 30 are not purely geometrical polygons, but rather, have rounded corners. A radius of curvature of the rounded corners account for a fraction of an edge length (e.g., less than or at most a quarter of the edge length) of such a polygon. In these exemplary embodiments shown in FIG. 2 to 4, the copper wires 30 are placed next to one another without gaps, so that the filling factor is almost 100 percent.

The electric machine 10 includes a hydrogen cooling circuit (not shown in detail). The copper tube 60 forms part of a hydrogen cooling path of the hydrogen cooling circuit for cooling the stranded wires 40. By the hydrogen cooling path, gaseous hydrogen may be conducted by the copper tube 60 through the stranded wires 40, so that the stranded wires 40 may be efficiently cooled.

As in the exemplary embodiment shown in FIG. 3, the plastic tube 50 may have a rectangular cross-sectional contour that corresponds to a likewise essentially rectangular recess, a groove 100, of the electric machine 10. The plastic tube 50 is pressed into the groove 100.

The hybrid electric aircraft 200 shown in FIG. 5 has the electric machine 10 in the form of an electric motor. The electric machine 10 drives a propeller 210 of the aircraft 200 to drive the aircraft 200.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electric machine comprising:
at least one winding comprising:
at least one electrical conductor with a non-circular-symmetrical cross section; and
at least one cooling fluid conductor with a non-circular-symmetrical cross section.

2. The electric machine of claim 1, wherein the at least one cooling fluid conductor does not completely circumferentially surround the at least one electrical conductor.

3. The electric machine of claim 1, wherein the at least one cooling fluid conductor has a cross section that is a same size as the at least one electrical conductor.

4. The electric machine of claim 1, wherein for the at least one electrical conductor, the at least one cooling fluid conductor, or the at least one electrical conductor and the at least one cooling fluid contdoctor, at least the cross section of the at least one electrical conductor or of the at least one cooling fluid conductor has at least 2-fold and at most 6-fold rotational symmetry.

5. The electric machine of claim 1, wherein the cross section of the at least one cooling fluid conductor, the cross section of the at least one electrical conductor, or the cross section of the at least one cooling fluid and the cross section of the at least one electrical conductor form a polygon.

6. The electric machine of claim 5, wherein the polygon forms a triangle, square, rectangle, or hexagon.

7. The electric machine of claim 1, wherein the cross section of the at least one cooling fluid conductor, the cross section of the at least one electrical conductor, or the cross section of the at least one cooling fluid conductor and the cross section of the at least one electrical conductor form a rounded polygon.

8. The electric machine of claim 7, wherein the rounded polygon forms a rounded triangle, square, rectangle or hexagon.

9. The electric machine of claim 1, wherein the at least one cooling fluid conductor is formed by at least one hollow conductor.

10. The electric machine of claim 1, wherein the at least one cooling fluid conductor is formed by at least one adjacent electrical conductor of the at least one electrical conductor.

11. The electric machine of claim 1, wherein the at least one cooling fluid conductor is formed by plastic, by at least one metal, or by the plastic and the at least one metal.

12. The electric machine of claim 1, wherein the at least one electrical conductor and the at least one cooling fluid conductor form a stranded wire.

13. A hybrid electric vehicle comprising:
an electric machine comprising:
at least one winding comprising:
at least one electrical conductor with a non-circular-symmetrical cross section; and
at least one cooling fluid conductor with a non-circular-symmetrical cross section.

14. The hybrid electric vehicle of claim 13, further comprising at least one cooling circuit that has the at least one cooling fluid conductor.

15. The hybrid electric vehicle of claim 13, wherein the hybrid electric vehicle is an aerial vehicle or an aircraft.

16. The electric machine of claim 2, wherein the at least one cooling fluid conductor is surrounded by the at least one electrical conductor.

17. The electric machine of claim 16, wherein the at least one cooling fluid conductor is surrounded completely circumferentially by the at least one electrical conductor.

18. The electric machine of claim 9, wherein the at least one cooling fluid conductor is formed by a tube, a hose, or the tube and the hose.

19. The electric machine of claim 11, wherein the at least one cooling fluid conductor is formed by copper, aluminum, or copper and aluminum.
